(19) United States
(12) Patent Application Publication
(10) Pub. No.: US 2015/0278078 A1
(43) Pub. Date: Oct. 1, 2015

(54) Method and computer program for identifying performance tuning opportunities in parallel programs

(71) Applicant: Akiyoshi Kawamura, Livermore, CA (US)

(72) Inventor: Akiyoshi Kawamura, Livermore, CA (US)

(21) Appl. No.: 14/224,240

(22) Filed: Mar. 25, 2014

(51) Int. Cl. G06F 11/36; G06F 9/44

(52) U.S. Cl. CPC G06F 11/3688; G06F 8/70

(57) ABSTRACT

From time to time we parallelize programs to improve execution time. In order to do so, one creates a number of execution units which can be executed concurrently. These execution units eventually are executed on hardware. It is often not clear what is the right number of execution units in achieving maximum runtime performance; too little or too much of them does not help in improving program execution time. The present invention presents a method and associated computer program for identifying performance tuning opportunities in parallel programs. The key information used by the method is execution start and end time of program regions such as blocks, functions or methods. This information can be visualized using VCD viewer and can be queried to check if a particular timing property is satisfied. The information then is used in identifying tuning opportunities and provides guides in parallelizing programs.

### PRIORITY STATEMENTS UNDER 35 U.S.C. §119(E) & 37 C.F.R §1.78

This non provisional application claims priority based upon the prior U.S. provisional patent application entitled, “Method and computer program for identifying performance tuning opportunities in parallel programs”, application No. 61/888,395, filed Oct. 8, 2013, in the name of Akiyoshi Kawamura.

### FIELD OF THE INVENTION

This invention relates to the field of performance tuning of parallel programs and, more particularly, to a method for identifying tuning opportunities in parallel programs using timing information (i.e. start and end time of program regions).

### BACKGROUND OF THE INVENTION

A handful of methods are used to improve computer program performance. Among them is performance analysis. Performance analysis, commonly known as profiling, aims to determine which sections of a program to optimize. The output of profiler includes the frequency and duration of function calls. This information is used to determine which sections of program are candidates for optimization. Once these candidates are identified, often it is not obvious to determine what needs to be done to bring execution time of these sections down. For example, in profiling a program, both gprof and VTune reported that the program spent more than 50% of its execution time on memory allocation. However, subsequent memory allocation optimization such as replacing the standard memory allocator with cache-aware or scalable one provided no improvement in overall program execution time.

Another approach to performance analysis is to use existing code instrumentation framework to collect performance data. There are many code instrumentation frameworks which are general enough that allow users to collect any type of performance data they wish. However these frameworks only provide the mechanism to collect performance data and leave users to figure out what performance data to collect.

### OBJECTS OF THE INVENTION

It is an object of this invention to present a method for identifying performance tuning opportunities in parallel programs.

Another object of this invention is to present computer program used in the method. The computer program includes 1) program for recording, processing program timing information, and saving it in VCD format and 2) program for querying timing properties.

Still other objects and advantages of the invention will in part be obvious and will in part be apparent from the specification and drawings.

### SUMMARY OF THE INVENTION

The technical problem to be solved in the present invention is to provide a method and computer program for identifying performance tuning opportunities in parallel programs.

In order to solve the above problem, the present invention provides a method comprising the following steps of:

a system recording execution start and end time of program regions such as blocks, functions or class methods, wherein:

start and end time time interval is associated with a particular name which will be used to correlate that time interval with corresponding program region and its data value at that particular time interval. The names and timing intervals are eventually recorded in value change dump (VCD) format. Name is recorded as VCD signal's name. Its signal value is set to 1 at start time and is set to 0 at end time.

user executes the application and collects timing information which get processed and recorded in VCD format.

user then can view this timing information using any VCD viewer, wherein:

timing relationship between related names which in turn indicates the timing execution relationship between related program regions.

This collected timing information is the key in identifying performance tuning opportunities. It is based on observation that one can change sections of a parallel program so that its execution timing relationship is satisfied efficiently. By satisfying timing relationship, its correctness is guaranteed. And by efficiently satisfying timing relationship, its correct behaviors have been tuned for performance purpose.

Another aspect of the invention is a method for collecting information from concurrently executed execution units. Data collection is performed in parallel. Collected timing information is sent to a central program using socket communication. The information will be written into a file sequentially. This file will be processed and as an end result, a VCD file is generated.

Still another aspect of the invention is a method for encoding program's data into VCD signals. With such data encoding scheme, users can sort or group related signals. That will help in identifying performance tuning opportunities.

Yet another aspect of the invention is to automate the process of identifying performance tuning opportunities using computer program. In particular, computer program assists users in querying timing properties such as how well a group of program sections satisfy a particular timing relationship.

These and other features of the invention will be more readily understood upon consideration of the attached drawings and of the following detailed description of those drawings and the presently-preferred and other embodiments of the invention.

### BRIEF DESCRIPTION OF THE DRAWINGS

For a more complete understanding of the invention, reference is made to the following description and accompanying drawings, in which:

FIG. 1 shows how the present method of identifying performance tuning opportunities is used during performance tuning process;

FIG. 2 shows an example of VCD signals;

FIG. 3 illustrates portion of code embedded with calls to performance data collection macros;

FIG. 4 shows steps involved in generating VCD file from collected timing information;

FIG. 5 shows an example of visual timing information using a VCD Viewer GTKWave;

FIG. 6 shows a serial algorithm for discovering sequence of grouped integers from a given input sequence of integers;

FIG. 7 shows timing information of all the stages of the second pipeline;

FIG. 8 shows timing information of stage 1 of the first pipeline;

FIG. 9 shows time which individual input set get processed after replacing the first pipeline with parallel_while construct;

FIG. 10 shows time which individual input set get processed after replacing the first pipeline with parallel_invoke construct. Two groups of input sets are scheduled to be processed in parallel at a time;

FIG. 11 shows time which individual input set get processed after replacing the first pipeline with parallel_invoke construct. Input sets are divided into 20 blocks. These blocks are scheduled to be processed using parallel_invoke construct;

FIG. 12 shows execution time of the program using various input data;

FIG. 13 introduces terminologies used in querying timing properties; and

FIG. 14 illustrates user programs which query timing properties of the first and second pipelines.

### DETAILED DESCRIPTION OF THE PREFERRED EMBODIMENTS

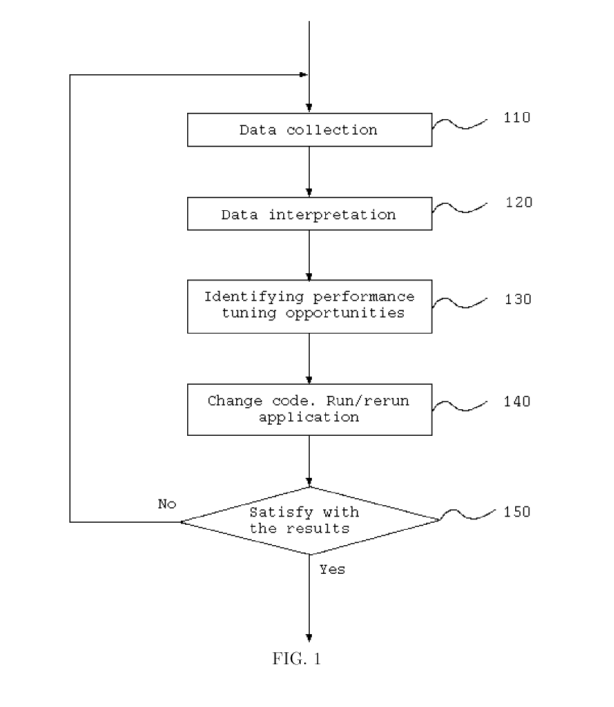

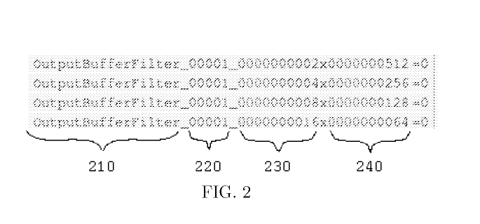

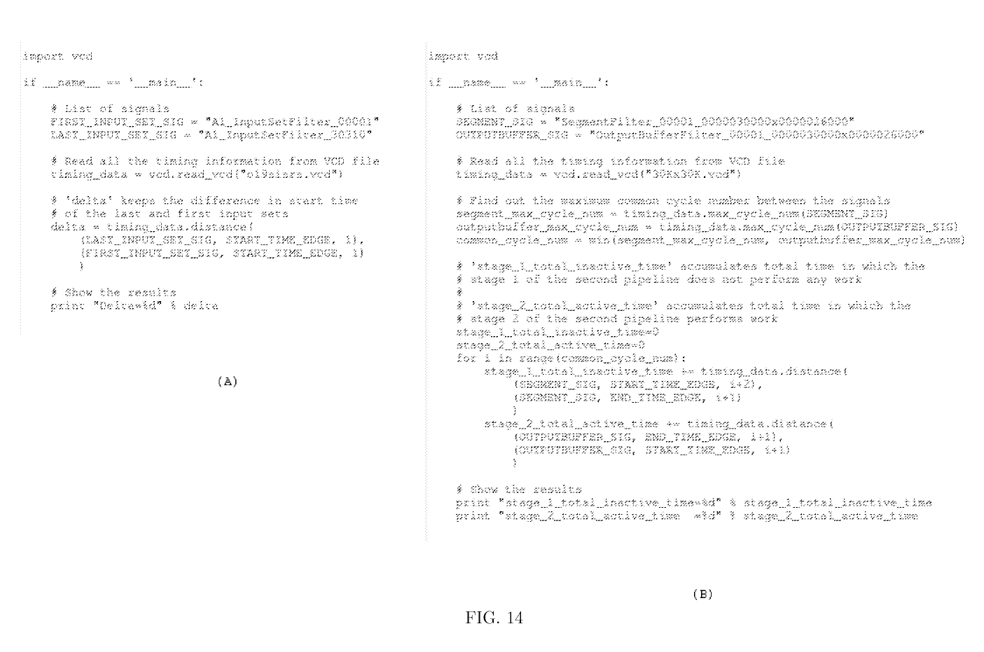

FIG. 1 illustrates how the method of identifying performance tuning opportunities is used during performance tuning process. The process includes 1) data collection 110, 2) data interpretation 120, 3) identifying performance tuning opportunities 130, 4) changing code and running/re-running application 140 and 5) making judgment if one satisfies with program's execution time 150. The whole process is executed over and over again until a satisfied solution is found. The preferred embodiment of the present invention will now be discussed with reference to FIG. 2 though FIG. 14.

### Data Collection 110

The first step in the whole process is data collection. The data collection technique of the preferred embodiment gathers the following timing information: start and end time of program regions such as blocks, functions or class methods. Each program region is assigned a particular name which will be used to correlate that time interval with a program region and its data value at that particular time interval. The collected information may be saved using the following representation: {(name, start_time, end_time)|name is the name assigned to a program region, start_time is the time recorded when that program region is started its execution and end_time is the time recorded when that program region is ended its execution}. The entries in this representation then eventually are recorded in VCD format. The name is recorded as VCD signal's name. Its signal value is set to 1 at start time and 0 at end time. When viewing timing information recorded in VCD file, we can group relevant signals together. That enables us to view signals in a comprehensive way and that allows us to interpret timing information in a more meaningful way.

FIG. 2 shows an example of VCD signals. In this example, timing information associated to execution of a class method called OutputBufferFilter is recorded. Since the method is called many times under different conditions, in order to distinguish one run from another, one needs additional information such as identifier of input set to be processed, associated data such as width and height. All of such information is encoded in VCD signal name, as shown in FIG. 2. Signal name OutputBufferFilter_{—}00001_{—}0000000002_{—}0000000512 is associated to OutputBufferFilter (substring 210) method while the method processes input set #1 (substring 220), width=2 (substring 230) and height=512 (substring 240).

Data recording can be done in various ways:
1. using Aspect-Oriented Programming (AOP)
2. calling pre-defined APIs supplied by library or macros
3. using compiler instrumentation
   In this present invention, macros are used to record data.

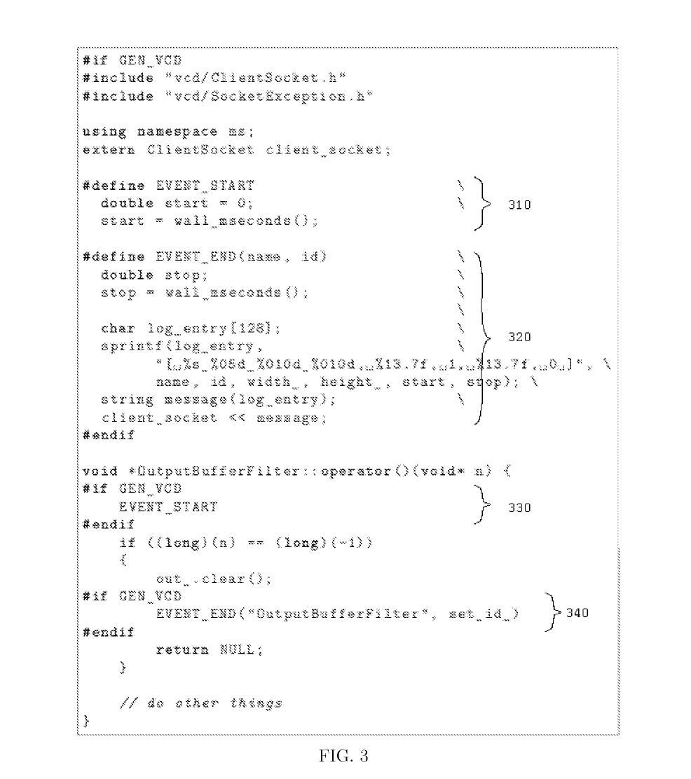

FIG. 3 illustrates portion of code which is embedded with calls to perform data collection. EVENT_START macro 310 is a macro used for recording when OutputBufferFilter method starts and EVENT_END macro 320 is a macro used for recording when the method ends its execution. This EVENT_END macro also constructs a message which represents the following timing information (signal_name, start_time, end_time). Lines 330 and 340 are data collection points where the two mentioned macros 310 and 320 are used.

Socket communication is used as a means for sending timing information. When a program is executed and reached to data collection points, a message will be constructed right after the execution end time is gathered. These messages will be sent to a pre-defined port associated to a particular host machine. This allows data collection to be done concurrently. There exists a program listening to the port mentioned. Once there is a message arriving to this port, the program will read from that port and then write the message to an internal file. Messages are written in the order they arrive to the port. Once a final message is received, this program terminates its execution. At this point, all the timing information are stored in the internal file.

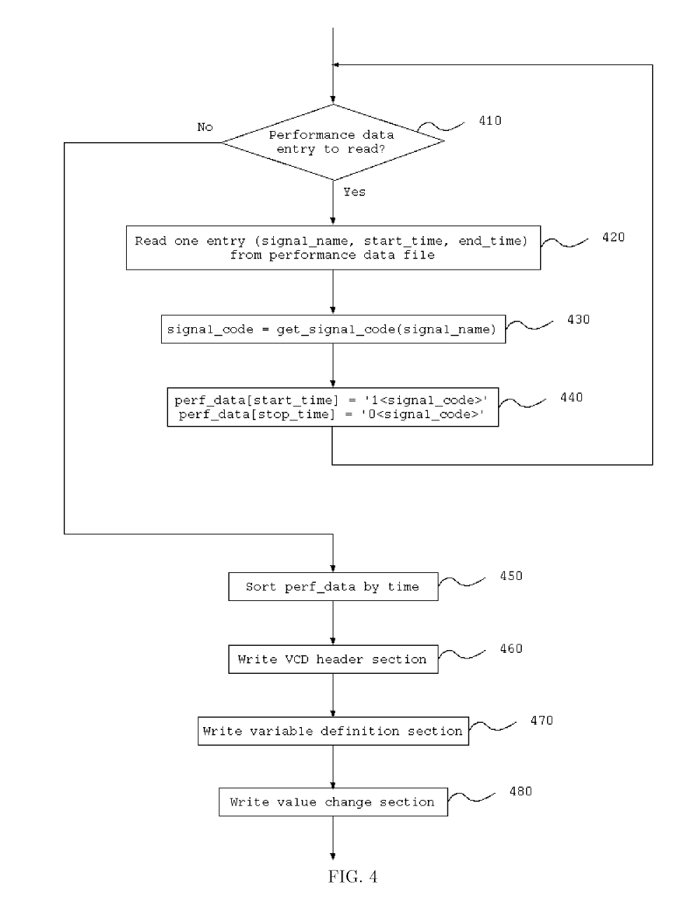

As illustrated in FIG. 4, another program will process the internal file and produce a VCD file which can be viewed using any VCD viewer. In step 410, the program checks if there is timing information to read. If there is, in step 420, it reads one timing information data entry recorded in the internal file which represented as (signal_name, start_time, end_time). The signal_name will be defined in variable definition section of corresponding VCD file. As part of the definition, a compact ASCII identifier is assigned to each signal_name. In step 430, an ASCII identifier lookup is performed by calling a function named get_signal_code. In step 440, timing information is stored in perf_data associative array. For start_time, the (key, value) is (start_time, ‘1C’), where “C” is the signal_code identified in step 430. And for end_time, the (key, value) is (end_time, ‘0C’), where “C” is the signal_code in step 430. In step 410, if there is no more timing data to read, the program starts to generate timing data in VCD format if there exist such data. Since timing data in VCD file is sorted by time, a sorting step in 450 is performed on the timing data kept in perf_data associative array mentioned in step 440. In step 460, VCD header section is generated. Information related to all of signal names used during data collection process is gathered in step 440. The information is referred to during generating VCD variable definition section in step 470. Finally, in step 480, timing data stored in perf_data is used to generate value change section of the VCD file.

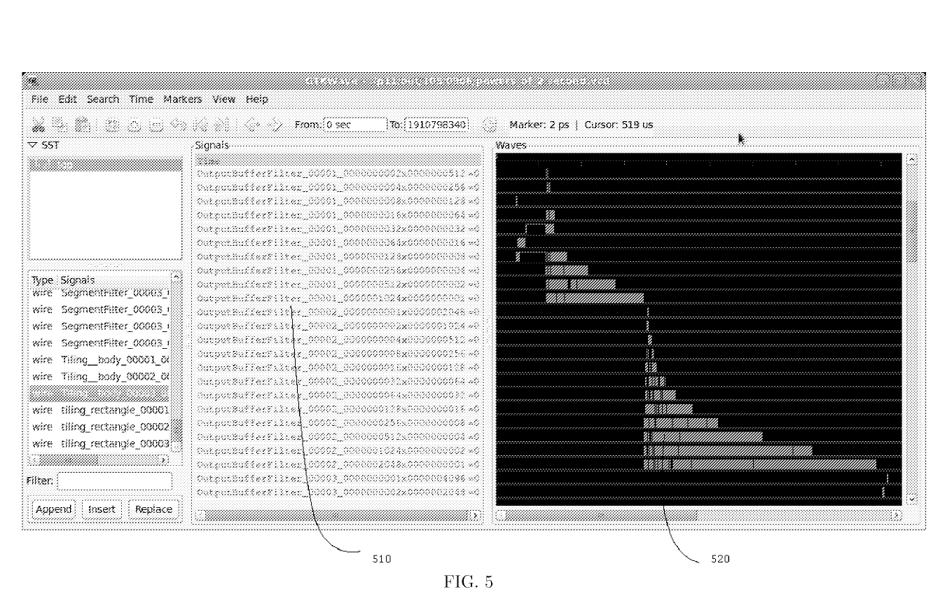

FIG. 5 shows an example of visual timing information using a VCD viewer GTKwave. The signal subwindow 510 is a list of signals which its timing information was gathered using macros 310 and 320. The signal's values are displayed in wave subwindow 520. Signal value is shown as a horizontal series of traces. Its value is set to 1 at the time the corresponding program region starts its execution. Its value is set to 0 at the end of its execution.

### Data Interpretation 120

In a parallel program, one implements the required functionality using a set of execution units. These units are often called tasks. The job of programmers is to orchestrate when to execute these tasks. The invented method is a perfect way for verifying if the orchestrations work as efficiently as possible. If they are not, they are candidates for performance tuning. The goal of this step is to identify all of these candidates by examining and interpreting collected timing information.

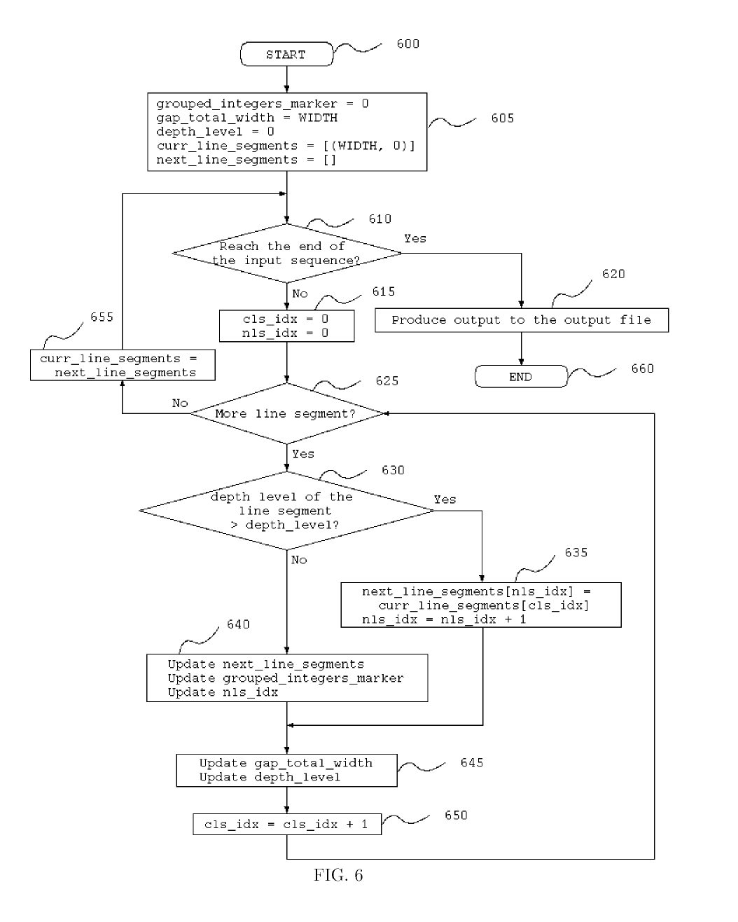

The preferred embodiment of the present method for identifying performing tuning opportunities will now be discussed with reference to FIG. 6 through FIG. 12. Tiling rectangle problem will be used throughout the discussion as a means to illustrate the present method.

### Tiling Rectangle Problem

Given a rectangular area with integral dimensions, that area can be subdivided into square subregions, also with integral dimensions. This process is known as tiling the rectangle. For such square-tiled rectangles, we can encode the tiling with a sequence of grouped integers. Starting from the upper horizontal side of the given rectangle, the squares are “read” from left to right and from top to bottom. The length of the sides of the squares sharing the same horizontal level (at the top of the tiling square) are grouped together by parentheses and listed in order from left to right.

A program implemented solution for this problem takes an input file which includes sequences of integers and produces an output file. The output file describes the result for each input sequence of integers in the input file. If there is no solution found for a given input sequence, a corresponding message “Cannot encode a rectangle” will be outputted.

For example, the 4×7 rectangle associated to input sequence 4 2 1 1 1 2 1 would be encoded as (4 2 1)(1)(1 2)(1).

### The Serial Algorithm

Since area of rectangle can be calculated using dimension width and height as well using sum of tiling squares, we notice the following relations:

area of rectangle=width*height=Σi² (1)

where the summation is performed over all the integers i in a given input sequence.

Also

width=Σi (2)

where i is the first i elements in the given sequence of integers.

These observations form the basic for designing algorithm used for discovering sequence of grouped integers from a given input sequence of integers. The algorithm will be introduced below, which comprises of the following steps.
1. Calculate area of rectangle by summing square of each integer in the given sequence as shown in (1)
2. Determine width using equation (2). Loop through all integers in the input sequence starting from leftmost integer, calculate sum of them and check if the calculated sum is a factor of the area of rectangle mentioned in step 1. At the end of this step, either all the widths which satisfy equations (1) and (2) are identified or no such width found. In the latter case, conclude that the input sequence has no solution and produce an output “Cannot encode a rectangle”
3. For a given width calculated in step 2, algorithm for discovering sequence of grouped integers will be introduced in FIG. 6.
   As is shown in the Figure, the algorithm is initiated from start block 600 whereupon flow is transferred to block 605 where the width calculated in step 2 is its input. At block 605, several variables are initialized. Variable grouped_integers_marker is set to zero and is used to mark the position of the end of a grouped integers. Variable gap_total_width is set to width and is used to maintain the total width of line segments which will be tiled in subsequent steps. Variable depth_level is set to zero and is used to indicate the smallest depth of line segments listed in list curr_line_segments. List curr_line_segments includes an element (width, 0) which indicates a line segment which has width equals to width and depth equals to zero. List next_line_segments is set to an empty one and is used to hold the list of line segments resulting in tiling line segments from the list curr_line_segments.
   Once the variables have been initialized, flow is transferred to decision block 610 in which it is determined if end of the input sequence has been reached. If it is, flow is transferred to block 620 where appropriate output will be produced in the output file and the algorithm is terminated at block 660. If it is not, flow is transferred to block 615. At block 615, index cls_idx is set to zero and is used to indicate which line segment in the list curr_line_segments is being processed. Similarly, index nls_idx is set to zero and is used to indicate which line segment in the list next_line_segments is being processed. Flow is then transferred to decision block 625 in which it is determined if all of line segments in the list curr_line_segments have been processed. If it is, flow is transferred to block 655 where the list curr_line_segments is replaced with the list next_line_segments. The flow is then transferred to block 610. At decision block 625, if it is not, flow is transferred to decision block 630.
   At block 630, it is determined if the depth level of the line segment is being processed is greater than the depth_level. If it is, then flow is transferred to block 635 in which the line segment is being processed in the list curr_line_segments is copied to the list next_line_segments. Then the index nls_idx is incremented. Flow is then transferred to block 645. At block 630, if the decision is not, then flow is transferred to block 640 where variables next_line_segments, grouped_integers_marker and nls_idx are updated accordingly. Then flow is transferred to block 645 in which variables gap_total_width and depth_level are updated accordingly. Variable gap_total_width is the sum of all line segments which have smallest depth. Variable depth_level is set to smallest depth of line segments in the list next_line_segments. Flow is then transferred to block 650 in which the index cls idx is incremented. Flow is then transferred to block 625.

### The Parallel Algorithm

Several parallel constructs provided by Intel® Threading Building Block are used to implement the parallel algorithm. The first version (V0) of the parallel algorithm uses two parallel pipelines and a parallel while constructs. The first parallel pipeline is for dealing with multiple input sets of sequence of integers. This pipeline has three stages: 1) read input set, 2) pre-process it and 3) perform tiling and write results into an output file. The stage 3 of the first parallel pipeline invokes parallel_while construct. Each parallel iteration of the parallel_while deals with a width mentioned in step 2 of the serial algorithm. In the process, it invokes a second parallel pipeline. This pipeline has three stages: first stage implements all the blocks mentioned in FIG. 6 except block 620; second stage writes the result to an output buffer and stage 3 writes the buffer to an output file.

### Identifying Performance Tuning Opportunities 130

Data collection has been performed in order to justify the effectiveness of the two parallel pipelines and parallel_while constructs used in the parallel algorithm. If there exists any ineffectiveness, there exist performance tuning opportunities by improving identified ineffective portions.

The use of parallel_while construct is effective. Processing time of all widths are dominated by the ones which have solution. Hence processing time of other widths are hidden and do not cause any impact on overall processing time.

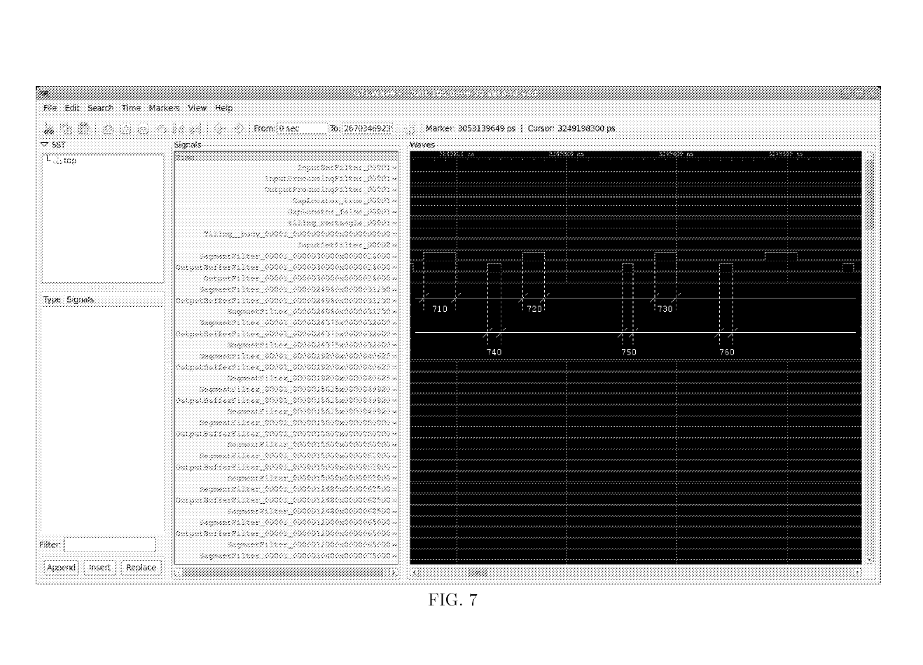

FIG. 7 shows timing information of all the stages of the second pipeline. These stage's modes are set to serial_in_order, meaning that each stage processes items one at a time. All serial_in_order filters in a pipeline process items in the same order. As indicated in FIG. 7, stage 1 of the second pipeline, whose associated signal is SegmentFilter_{—}00001_{—}0000030000x0000026000, processes one item at a time. Time intervals 710, 720 and 730 illustrate execution time of three consecutive items. Each time interval represents execution time of one iteration of the loop 625, 630, 635/640, 645, 650, 625. Similarly, stage 2 of the second pipeline, whose associated signal is OutputBufferFilter_{—}00001_{—}0000030000x0000026000, processes one item at a time. Time intervals 740, 750 and 760 illustrate execution time of three consecutive items. Once iteration related to block 710 is complete, its result is passed as an input item to stage 2 of the second pipeline. Its execution time is denoted as time interval 740. Relationship between time intervals 720 and 750, 730 and 760 is the same as the one between 710 and 740. Notice that time interval between time intervals 710 and 720 is larger than time interval 740. And time interval between time intervals 720 and 730 is much large than time interval 750. The observation questions the effectiveness of the second parallel pipeline usage and suggests that replacing the second parallel pipeline with a serial one would improve overall execution time. In fact, we know execution time of all items in the parallel pipeline version is 2,293,867,920 ns. We can also estimate the execution time of the three items in serial version by calculating sum of the following intervals 710, 740, 720, 750, 730 and 760. Estimated execution time of all items in serial version is 2,242,591,431 ns. We estimate that serial version is 2% faster than the parallel pipeline version.

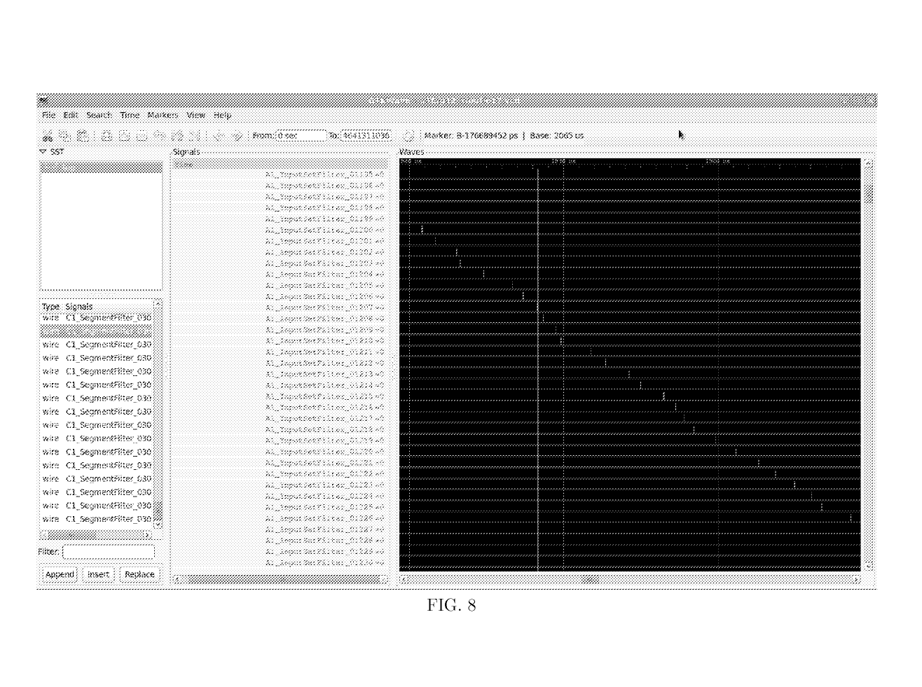

FIG. 8 shows timing information of stage 1 of the first pipeline. Each signal is associated to a particular input set. The waveforms illustrate that these stages are started sequentially. The last stage 1 associated to the last input set, is started 464 ns after the stage 1 associated to the first input set get started. This suggests that the more input sets we have the longer it takes to start to process the last input set. If we can let the latter input sets to be processed earlier, there are better chances that the overall program execution time get improved.

As illustrated in the examples, one can examine timing information recorded in VCD waveforms and utilize the information in identifying performance tuning opportunities.

Changing Code. Examining New Results 140 and 150

In step 140 necessary code change will be made to explore performance tuning opportunities found in step 130. After that, we run the application again, then check the results to see if there is any improvement in overall execution time. If we satisfy with the results the task of performance tuning is complete. Otherwise we start the tuning process as mentioned in FIG. 1 again.

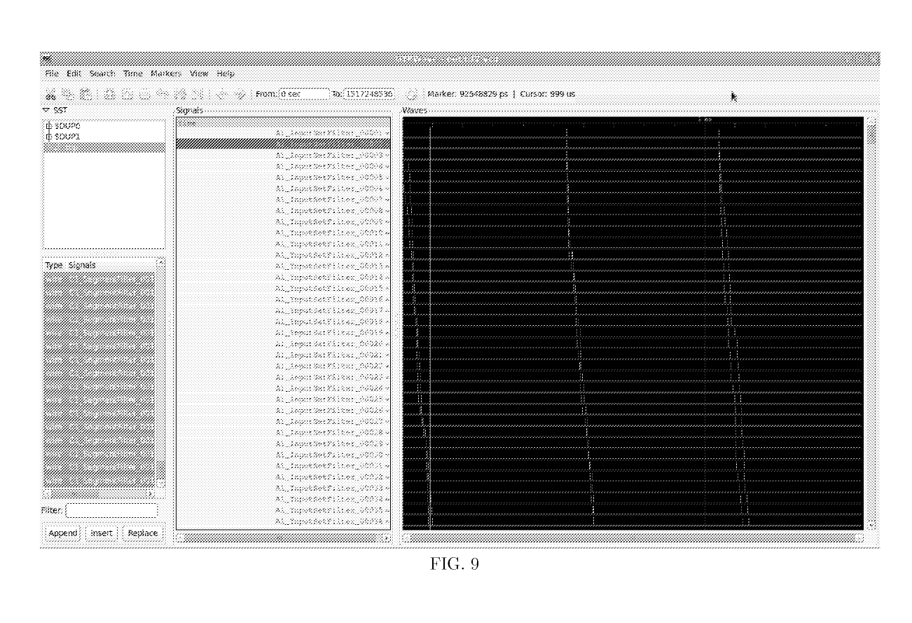

Code change with respect to performance tuning opportunities found in step 130 and the results will now be discussed with reference to FIG. 9 through FIG. 12.

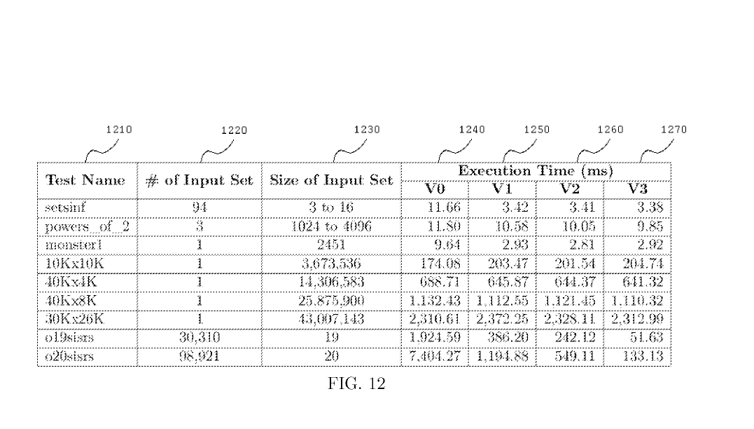

For the first tuning opportunity with the second pipeline, I simply merged stages 1 and 2 of the second pipeline. As shown in FIG. 12—column 1250, I observed that for test cases which have a large number of input sets (i.e. o19sisrs and o20sisrs), program ran between 6 to 7 times faster. For test cases with a large single input set (i.e. 10K×10K and 30K×26K) program ran up to 16% slower. For other test cases with large single input set (i.e. 40K×4K and 40K×8K) program ran up to 6% faster. For input sets with small size, the benefit of splitting work to smaller pieces is dismissed due to overhead of having too many threads. Therefore, merging stages of the second pipeline helps program run significantly faster on input sets such as o19sisrs and o20sisrs. Note that comparison is done against the first version (V0) where its execution time is listed in FIG. 12—column 1240.

The performance issue with stage 1 of the first pipeline is that it starts to process latter input sets too late. There are no real control and data dependencies between processing stage 1 items except the input set to be processed needs to be identified sequentially. I replaced the first pipeline with parallel_while construct. Identifying input set is still performed sequentially but once it is discovered, the processing of input set is performed in parallel. As illustrated in FIG. 9, processing of input sets is started in parallel in this version. Due to limit of hardware threads, not all input sets are started processing in parallel. I observed that overall program execution time got worse. The cause can be attributed to over-subscription; there are two much work which are scheduled at once on a limit number of hardware threads.

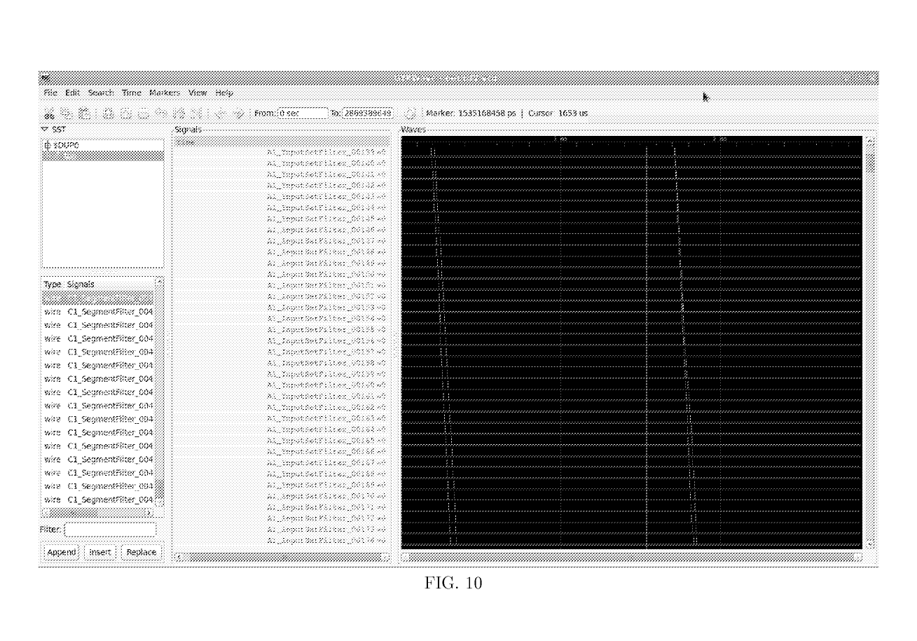

Now instead of starting to process all the input sets at once, I grouped them into groups. Then I started two groups in parallel at a time and then I started another two groups in parallel. It was repeated until all the groups started. Within each group, input sets were processed sequentially. The aim was to address issue with over-subscription by reducing number of input sets to be scheduled to process concurrently. As illustrated in FIG. 10, comparing to the approach using parallel_while construct, number of input sets which were started processing concurrently were reduced. As shown in FIG. 12—column 1260, I observed a better overall execution time with this approach. The remain question is whether this is an optimal performance tuning solution.

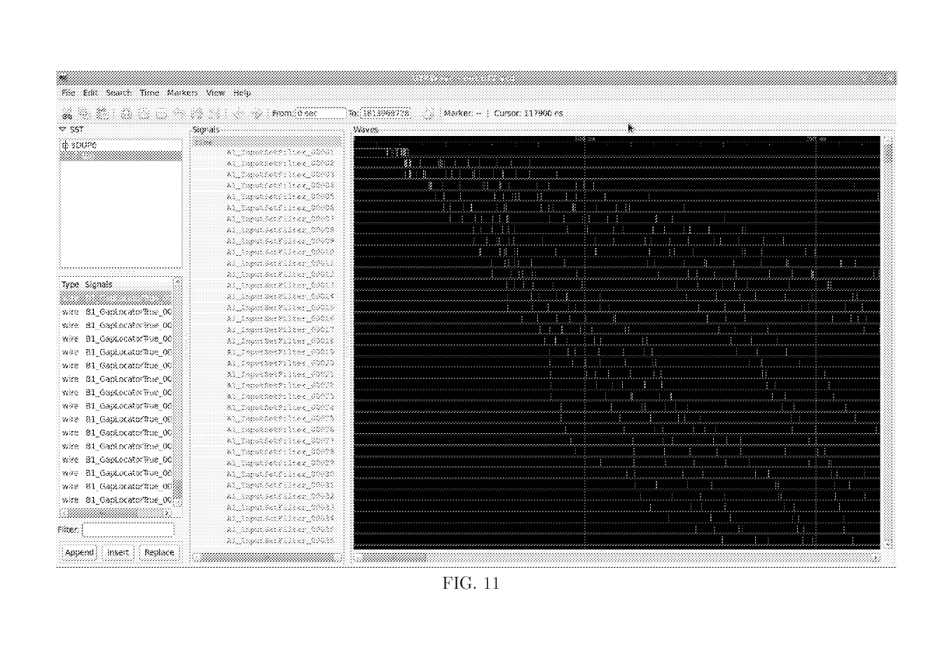

I increased the number of groups to be scheduled in parallel, starting from 2 and then to 4, 6, 8, 10, 12, 16, 20 and finally 24. I observed that with the two o19sisrs and o20sisrs test cases, the best performance number was observed when number of groups equals to 20. FIG. 11 shows timing information related to stage 1 of the first pipeline. As shown in FIG. 12—column 1270, overall execution time was improved.

The table in FIG. 12 shows execution time of the program using various input data. Column 1210 lists all the test cases. Columns 1220 and 1230 describe properties of these test cases: number of input sets and the size of input set in each test case respectively.

There are four different program versions: V0, V1, V2 and V3. Their execution time on different test cases is listed in corresponding column 1240, 1250, 1260 and 1270 respectively.

Version V0 is base version.

Version V1 is based on the base version V0 with performance tuning performed on the second pipeline (i.e. merging stage 1 and 2 of the second pipeline).

Version V2 is based on version V1 with the following performance tuning operations: 1) remove the first pipeline, 2) divide input sets into multiple groups, starts two of groups in parallel, and then starts another two groups in parallel and so on. Input sets within a group are processed sequentially.

Version V3 is based on version V1 with the following performance tuning operations: 1) remove the first pipeline, 2) divide input sets into 20 groups, then start all of them in parallel. Input sets within a group is processed sequentially.

### Assisting the Process of Identifying Performance Tuning Opportunities

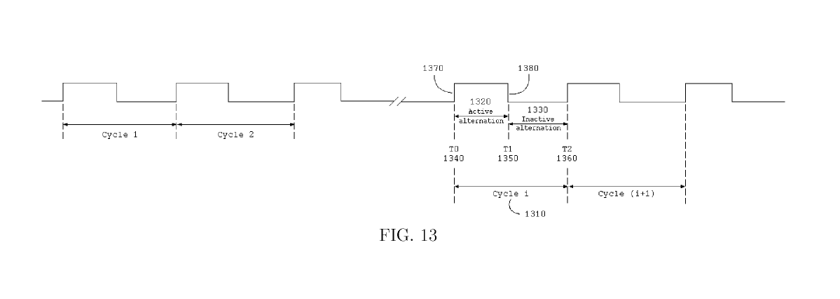

The whole manual process of identifying performance tuning opportunities 130 can be automated with assistance of computer program. In addition to visually inspecting waveforms, one can write program to investigate timing properties in VCD file. The technique with which timing properties are extracted for identifying performance tuning opportunities according to the preferred embodiment will now be discussed with reference to FIG. 13 and FIG. 14.

FIG. 13 introduces terminologies used in querying timing properties. Each waveform signal comprises of many cycles. Each cycle has two alternations of equal or unequal duration: active alternation and inactive alternation. For example, cycle i 1310 has active alternation 1320 and inactive alternation 1330. Active alternation starts at start time T0 1340 and ends at end time T1 1350. Inactive alternation starts at T1 1350 and ends at T2 1360. Rising edge 1370 is called start time edge. Falling edge 1380 is called end time edge. Start time or end time edge can be represented using the following representation: {(name, edge_type, cycle_number)|name is the name of signal assigned to a given program region, edge_type is either START_TIME_EDGE or END_TIME_EDGE and cycle_number is the cycle number indicating which cycle the edge belong to}.

The basic components of the technique are as follows:

A library module comprises of predefined methods used for dealing with timing information in VCD file. The module provides a method called read_vcd which reads timing information stored in a VCD file and returns a data structure which holds the information. In the present invention, this data structure is a class. The class provides two methods 1) max_cycle_num and 2) distance. Method max_cycle_num returns the maximum cycle number of a given signal. Method distance returns distance in time between two edges.

A user program specifies timing properties which user is interested in. User program uses the methods available from the library module to specify timing properties. User will eventually run the program to find out if specified timing properties are satisfied.

In the present invention, both library module and user program are implemented in Python language. FIG. 14(A) illustrates a user program investigates timing interval between start time when the first input set get processed and start time when the last input set get processed. The timing information is used to identify performance tuning opportunities with the first pipeline mentioned at step 130. FIG. 14(B) illustrates a user program calculates sum of all active alternations related to signal SegmentFilter 00001 0000030000x0000026000 and sum of all inactive alternations related to signal OutputBufferFilter_{—}00001_{—}0000030000x0000026000. This information leads to performance tuning opportunity in the second pipeline as mentioned in step 130.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is my intent they be deemed within the scope of my invention.

What is claimed:

1. A method comprising steps of:
modifying application to insert data collection points;
executing the application to collect timing information;
interpreting timing information and utilizing them in identifying performance tuning opportunities; and
changing code and rerunning the application.

2. The method according to claim 1 in which the step of data collection from concurrently executed execution units is possible.

3. The method according to claim 1 in which program's regions and their data are encoded into VCD signals.

4. The method according to claim 1 in which a program assists user in identifying performance tuning opportunities by querying specified timing properties from collected timing information.

5. A computer program embodied on a non-transitory computer readable medium and comprising code that, when executed, causes a computer to perform the following:
collecting timing information;
sending the collected information over network; and
saving the aggregated timing information to one or more files.

6. The computer program of claim 5 wherein C++ is used to implement said functionalities.

7. A computer program embodied on a non-transitory computer readable medium and comprising code that, when executed, causes a computer to perform the following:
generating a VCD file from collected timing information.

8. The computer program of claim 7 wherein Python language is used to implement said functionality.

9. The computer program of claim 4 embodied on a non-transitory computer readable medium and comprising code that, when executed, causes a computer to perform the following:
querying timing information based on timing specification specified in a user program.

10. The computer program of claim 9 comprises of the following components:
a library program provides methods for reading timing information stored in VCD file; and
a user program specified timing specification user is interested in.

11. The computer program of claim 10 wherein Python language is used to implement said functionality.
